(19) United States
(12) Patent Application Publication
(10) Pub. No.: US 2004/0226875 A1
(43) Pub. Date: Nov. 18, 2004

(54) Filtration module

(76) Inventors: Andrew Bartlett, Lowell, MA (US); Mark Chisholm, Arlington, MA (US); George Gagne, Dracut, MA (US); Robert Jackson, Rindge, NH (US)

Correspondence Address: MILLIPORE CORPORATION, 290 CONCORD ROAD, BILLERICA, MA, 01821, US

(21) Appl. No.: 10/805,032

(22) Filed: Mar. 19, 2004

Related U.S. Application Data
(60) Provisional application No. 60/470,761, filed on May 15, 2003.

(51) Int. Cl. B01D 63/00

(52) U.S. Cl. 210/321.6; 210/483; 210/488; 210/489

(57) ABSTRACT

A filtration module is provided having a packing density of at least 300 square meters of active membrane filter area per cubic meter of external volume of said filter construction, said filter constructed of materials characterized by less than 250 mg of extracted contamination per m² of extracted wetted material. The filtration module includes a membrane composite layer comprising a filtrate screen sealed to each surface of a membrane layer with a thermoplastic polymeric composition positioned about the periphery of the filtrate screen.

This invention relates to a membrane filtration apparatus for effecting filtration of a liquid composition wherein a feed liquid is introduced into the apparatus and a filtrate stream and, optionally a retentate stream are removed from the apparatus. More particularly, this invention relates to a tangential flow membrane filtration apparatus or dead-ended membrane filtration apparatus that is formed and selectively sealed by heat sealing membrane layers to a filtrate spacer layer with a thermoplastic polymeric composition in the filtrate spacer layer.

### BACKGROUND OF THE INVENTION

Prior to the present invention, liquids have been filtered within a plurality of filter modules that are stacked between manifolds or individually sealed to a manifold plate. Each module includes a one or more filter layers separated by appropriate number of spacer layers, such as screens, to permit liquid feed flow into the apparatus as well as filtrate flow from the apparatus. Filtration within the module can be conducted as a tangential flow filtration (TFF) process wherein incoming feed liquid is flowed tangentially over a membrane surface to form a retentate and a filtrate. Alternatively, filtration can be conducted as a dead end mode otherwise identified as normal flow filtration (NFF) wherein all incoming feed liquid is passed through a membrane filter with retention of solids and other debris on the membrane filter. In this latter mode only a filtrate is recovered.

At the present time, a filtrate stream is sealed from a feed stream within a membrane filtration apparatus by sealing a filtrate spacer layer to two porous membrane layers with sealing techniques utilizing potting adhesives such as epoxies, urethanes or silicones. In the case of a tangential flow filtration apparatus, a filtrate stream is sealed from a feed stream and a retentate stream. Adhesives are undesirable since they have limited chemical compatibility, are a source of significant extractable species, limits the ability to utilize all of the given volume in a filter unit as the adhesives take up a given volume or area in the device, introduce process control difficulties, impose bond strength limitations, impose use temperature limitations, and increase process cycle time. Solvent bonding is undesirable since solvents impose environmental issues and manufacturing process variability while potentially useful polymers are limited by their solvation characteristics. In addition, it has been proposed to modify the edges of the membrane layers by adding a polymeric thermoplastic sealing composition to a membrane layer surface. The polymeric thermoplastic sealing composition is then used to seal the membrane to an adjacent spacer layer. Since intrusion of the polymeric thermoplastic sealing composition into the membrane layer is limited by the small pores of the membrane, the strength of the seal between the sealing composition and the membrane is relatively low. In addition, the limited intrusion of the sealing composition results in an undesirable increase in the membrane layer which increases the volume of the adjacently positioned spacer layers thickness thereby causing an undesirable reduction of membrane filter surface area per unit volume of the final filtration module and a reduction of filtration capacity of the final filtration module.

In addition, the use of materials such as polysilicone or polyurethane based materials which absorb and/or adsorb a portion of a feed fluid being filtered is undesirable since the absorbed material will desorb into subsequently filtered materials and contaminate them.

U.S. Pat. No. 5,429,742 discloses a filter cartridge comprising a thermoplastic frame into which are molded a plurality of filtration membranes. The thermoplastic frame is molded to provide fluid pathways that assure incoming fluid to be filtered will be passed through a membrane prior to removing filtered fluid from the filter cartridge. The frame is sufficiently thick so that fluid pathways to and from the membranes can be formed. Since adjacent membranes are separated by relatively thick spacer members, membrane area per unit volume of the filter cartridge is undesirably low.

Accordingly, it would be desirable to provide a multilayer filtration apparatus that utilizes a plurality of filtration elements wherein the layers are appropriately sealed without the use of adhesive or solvent bonding. Moreover, it would be desirable to provide a tangential flow or a dead ended filtration apparatus containing a large number of filtration layers per volume of filtration apparatus which can be formed into a stack and which has packing density of active membrane to external filter volume of at least 300 m²/m³. In addition, it would be desirable to provide a tangential flow or a dead ended filtration apparatus containing a large number of filtration layers per volume of filtration apparatus which can be formed into a stack and which can be appropriately sealed to define liquid flow paths within the stack. Furthermore, it would be desirable to provide such a filtration apparatus formed of a material which minimizes or eliminates absorption (also adsorption) and subsequent desorption of a material being filtered. Such a filtration apparatus would provide a high filtration capacity and would permit multiple uses of the apparatus while minimizing or eliminating filtrate contamination problems.

### SUMMARY OF THE INVENTION

The present invention provides a thermoplastic filtration apparatus having a packing density of at least 300 m² of active membrane area/m³ external volume of filtration apparatus. Additionally, the apparatus of this invention is formed of compositions, which are substantially free of extractable materials either prior to or subsequent to filtration. As used herein, the phrase “substantially free of extractables” means less than 250 mg of extracted contamination per m2 of material when soaked with a test solution containing one or more acids and then placed into deionized water and allowed to soak to cause any adsorbed or absorbed acid to leach out.

The filtration apparatus is formed of a stack of membranes and spacers that are alternatively positioned through the vertical height of the filtration apparatus and are sealed in a manner more fully described below.

In addition, the present invention provides a filtration apparatus formed of filtration elements that are sealed with a thermoplastic polymeric composition in a manner that promotes sealing of a spacer layer to a polymeric porous membrane while avoiding thermal or mechanical degradation of the membrane. Selective sealing of the porous polymeric membrane is effected in a two-step process wherein the periphery of at least a filtrate spacer and optionally a feed spacer is sealed. The thermoplastic polymeric composition can be secured to the spacer layer in any manner such as by attachment, intrusion, extrusion or insert molding in a first step with a thermoplastic polymeric composition to secure the thermoplastic polymeric composition to the membrane. The shape of the thermoplastic composition controls fluid flow within the spacer in a manner described below. In a second step, the peripherally positioned thermoplastic polymeric composition of the filtrate spacer is sealed on each opposing surface with a supported or unsupported membrane to form a sandwich of two membrane layers and a filtrate screen layer. Optionally, only one surface of the filtrate spacer is sealed with a membrane with sealing being provided such as with a compressible elastomeric polymer to prevent mixing of filtrate with either feed or retentate The defined fluid flow paths within the feed screen and filtrate screen (spacer layers) assure that fluid to be filtered to form the filtrate passes through a membrane prior to being removed from the filtration apparatus. Sealing is effected of a single set of a membrane and a spacer layer sequentially until a desired stack of alternately positioned membranes and spacer layers is sealed in the desired configuration.

In accordance with this invention, a dead ended (NFF) or tangential flow filtration (TFF) apparatus is provided which includes a plurality of spaced-apart membranes and a plurality of spacer layers having channels or openings that promote liquid flow therethrough. The NFF filtration apparatus is provided with at least one feed port and at least one filtrate port. The tangential flow filtration apparatus is provided with at least one feed port, at least one filtrate port and at least one retentate port. Membrane layers and spacer layers are alternated through the vertical height of the filtration apparatus in selected patterns.

Selective sealing of the membrane layers and the spacer layers is effected in a two-step process. In a first step, a thin layer of a thermoplastic polymeric composition is molded into the periphery of each filtrate spacer layer on each surface of the filtrate spacer layer and, optionally each feed spacer layer. The thermoplastic polymeric composition is subsequently caused to flow by exposing it to energy such as heat or ultrasonic waves to that it is caused to bond to membrane layers. When the feed spacer layer is not molded with a thermoplastic polymeric composition, it is molded with a compressible polymeric composition that can be compressed to form a fluid seal when the apparatus of this invention is in use. The thermoplastic polymer composition is molded in a pattern which effects desired fluid flow through the modules. The thus treated spacer layers and membranes are then stacked in a manner to preliminarily form a feed port, a filtrate port and, in the case of a tangential flow module, a retentate port.

The final step of sealing thermoplastic polymeric composition to form the module then is selectively effected to form fluid flow channels that separate feed and retentate from filtrate within the module. In the case of a tangential flow filtration apparatus, liquid flow within the stack is assured by sealing the feed inlet and the retentate outlet from the filtrate outlet.

The outer portion of the filtration apparatus is then formed by insert molding or potting with a thermoplastic or thermoset polymeric construction. Insert molding is accomplished by positioning the stack within an injection mold and injecting the molten polymeric composition into the mold to effect sealing in a manner that assures the desired liquid flow within the final membrane filtration apparatus during use. The stack comprises feed spacer layers alternating with a composite layer comprising a filtrate space layer bonded to two membrane layers. The number of alternating feed spacer layers and composite layers is a matter of choice. The feed spacer layers adjacent to the feed port that are designated to accept feed remain in liquid communication with the feed channel. Channels that accept either retentate or filtrate also extend into the stack. The channels that accept retentate are sealed from the filtrate spacer layers and are in fluid communication with the spacer layers that are also in fluid communication with the feed port. The channels can extend through the membranes. The port or ports that accept filtrate are sealed from the spacer layers that accept feed or retentate and are in fluid communication with the spacer layers that accept filtrate. The stack is also sealed in a manner so that liquid feed entering the feed spacer layers must pass through a membrane before entering a filtrate spacer layer.

### BRIEF DESCRIPTION OF THE DRAWINGS

FIG. 1 is a top view of a feed spacer layer of this invention.

FIG. 2 is a cross-sectional view of the spacer layer of FIG. 1 taken along line 2-2.

FIG. 3 is a top view of a filtrate spacer layer of this invention.

FIG. 4 is a cross-sectional view of the spacer layer of FIG. 3 taken along line 4-4.

FIG. 5 is a cross-sectional view of a composite layer of this invention comprising two membrane layers and a filtrate spacer layer.

FIG. 6 is a cross-sectional view of the composition layer of FIG. 5 and two feed spacer layers of this invention.

FIG. 7 illustrates fluid flow through a tangential flow filtration module of this invention.

FIG. 8 illustrates fluid flow through a tangential flow apparatus of this invention.

FIG. 9 is a perspective view in partial cross-section of a filtration apparatus of this invention.

FIG. 10 is a graph showing the relative extractable levels of a variety of polymeric compositions.

### DESCRIPTION OF SPECIFIC EMBODIMENTS

The present invention utilizes filtration membrane elements that can be selectively sealed in a stacked configuration to effect separation of filtrate from feed or feed and retentate. The filtration membrane element comprises a spacer layer having the periphery thereof bonded to a thermoplastic polymeric composition. When exposed to energy comprising heat energy such as fusion, vibration or radiant heat or a non-heat energy such as ultrasonic energy which is absorbed by the thermoplastic polymeric composition and converted to heat energy, the thermoplastic polymeric composition preferentially melts prior to the main body of the spacer layer. This feature permits controlling selective areas of a filtration apparatus to be sealed.

The filtration membrane and spacer layer elements can be sealed one-by-one to each other or can be sealed to each other in a desired configuration in a one-step process while positioned in a stack of filtration membrane elements and spacer layer of this invention.

The filtration membrane elements useful for forming the filtration module of this invention are formed by modifying an end of a spacer layer by sealing a thermoplastic polymeric composition (TPC) to an edge or perimeter of the spacer layer. The (TPC) surfaces can be sealed to adjacent (TPC) surfaces to effect sealing in a manner that effects sealing of alternatively positioned spacer layers in a stack of membranes alternating with spacer layers. Sealing is effected so that each feed spacer has inlet holes on opposing surfaces thereof that communicate with incoming feed and filtrate holes which are sealed from incoming feed. In contrast, the filter spacer layers have holes that are sealed from incoming feed and holes in fluid communication with filtrate. By operating in this manner, mixing of filtrate with either a feed stream or retentate stream is prevented and incoming feed must pass through a membrane prior to passing through the filtrate spacer layer.

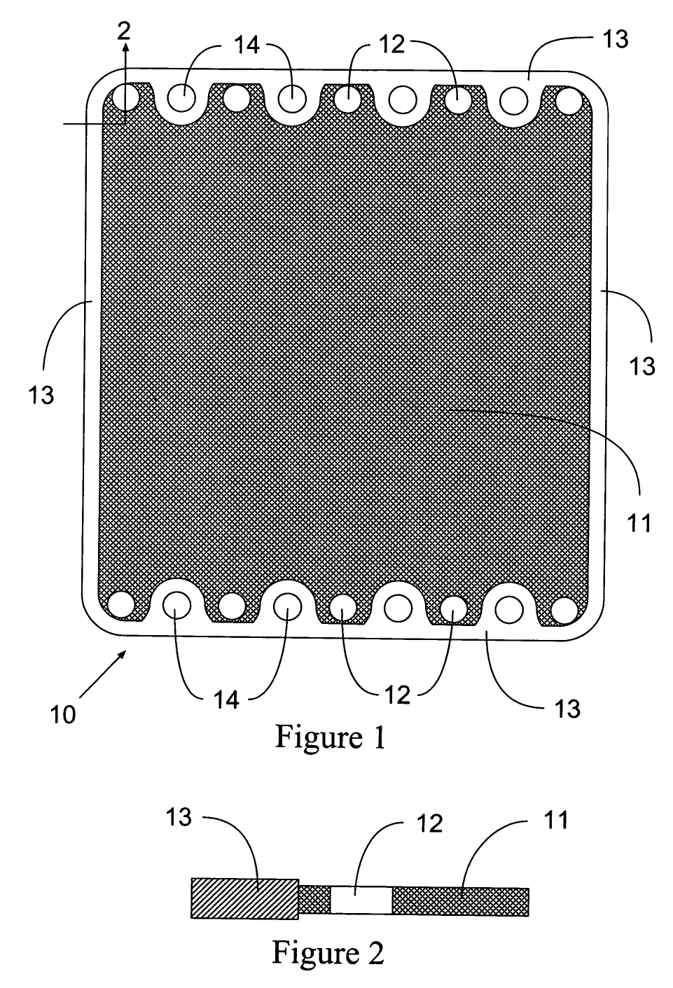

Referring to FIG. 1, a feed spacer layer 10 is shown comprising a screen 11, a plurality of feed holes 12 in fluid communication with screen 11 and a plurality of filtrate holes 14 which are not in fluid communication with screen 11. The periphery of the screen 11 is filtered with a thermoplastic polymeric composition 13 that can be heat-sealed or with a compressible polymeric composition 13 that can be compressed to effect a seal about the periphery of screen 11. As shown in FIG. 2, the polymeric composition is slightly thicker than the screen 11. It is essential that the thickness of the polymeric composition 13 be between about the same as and about 25% greater, preferably between about the same as and about 10% greater than the thickness of the screen 11 after being bonded to one or two membranes so that heat or compression sealing can be effected without an excess of the polymeric composition which would needlessly increase the volume of the filtration module of this invention. The starting thickness of the polymeric composition 13 prior to sealing is the same as or about 30% thicker than the thickness of the screen.

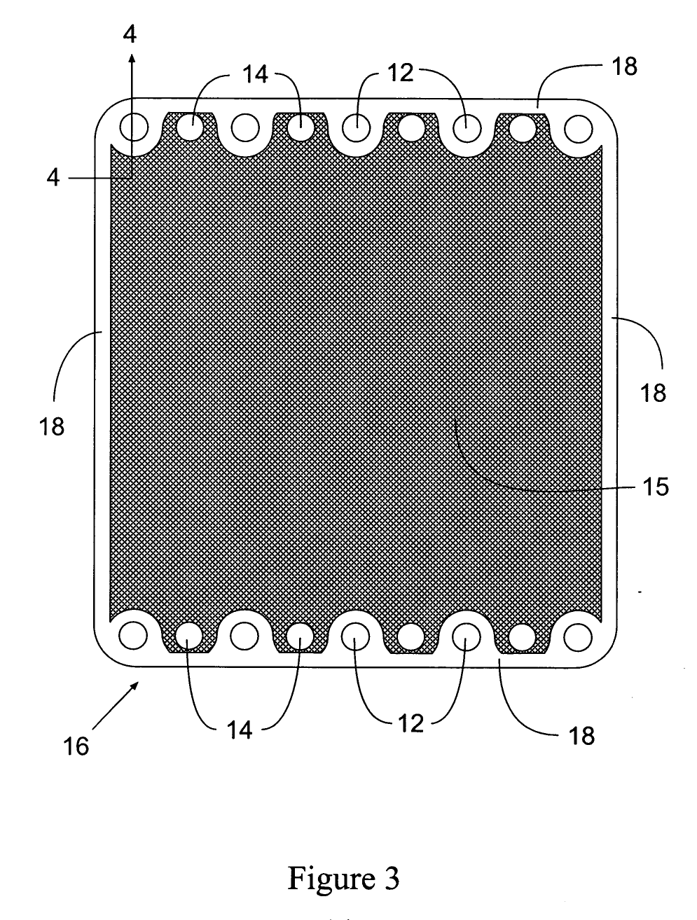

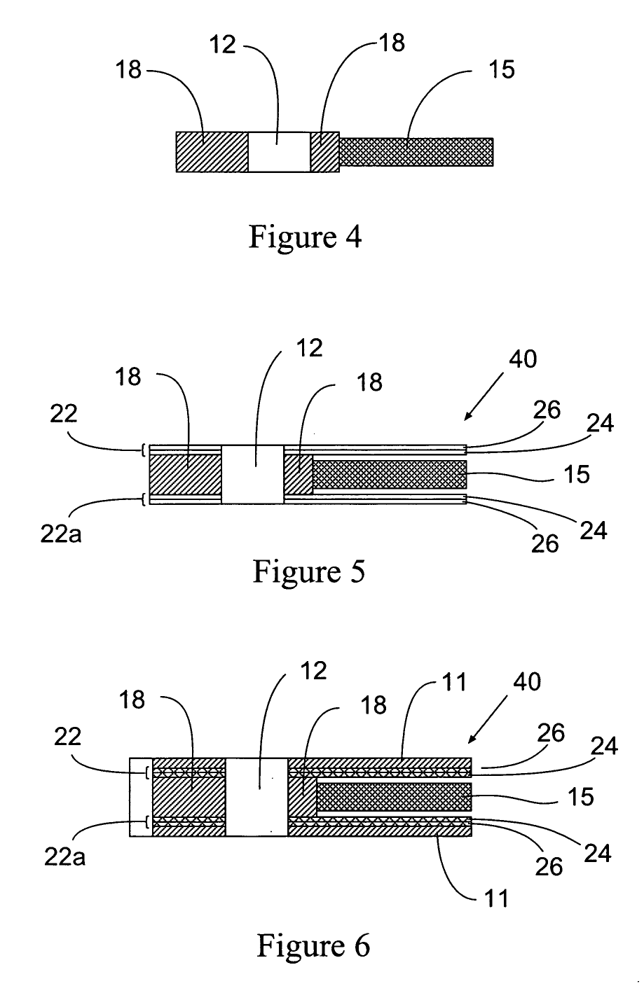

Referring to FIGS. 3 and 4, the filtrate screen 16 is shown wherein the feedholes 12 are sealed from the screen interior 15 with a thermoplastic polymeric composition 18 that extends about the periphery of the filtrate screen 16. Polymeric composition 18 is slightly thicker than the screen 16. Polymeric composition 18, is between about the same as and about 25% greater than, preferably between about the same as and about 10% greater than the screen 16 after being sealed for the reasons set forth above regarding polymeric composition 13. The starting thickness of the polymeric composition 18 prior to sealing is the same as or about 30% thicker than the thickness of the screen.

Referring to FIG. 5, a composite layer 20 of this invention is shown. The composite layer 20 comprises the filtrate screen 15 including the thermoplastic polymeric composition 18 and the feedhole 12. The filtrate hole 14 (FIG. 2) is in fluid communication with screen 15. The thermoplastic composition 18 is sealed to the membrane layers 22 and 22a. Each membrane layer 22 and 22a includes a porous support layer 24 such as a woven or nonwoven sheet such as a non-woven polypropylene fabric and an ultrafiltration layer 26 such as polyethersulfone or a composite of a cellulose layer and a polyethylene layer. Since screen 15 is in fluid communication with filtrate hole 14 and are sealed from feedhole 12, filter and feed are not admixed.

Referring to FIG. 6, a composite layer 28 is shown comprising two feed screens 11 in fluid communication with feed hole 12, two membrane layers 22 and 22a sealed from feed hole 12 by thermoplastic composition 18 and a filtrate screen 15 sealed from feed hole 12 by thermoplastic composition 18. Thus, composite layer 28 functions to accept feed through screen 11, through membrane layers 22 and 22a into feed through screen 11, through membrane layers 22 and 22a, into screen 15 and out from module composite layer 28 through filtrate holes 14 (FIG. 3). The composition layer 28 and other composition layers (not shown), are sealed with a thermoplastic polymeric composition about its periphery such as by injection molding.

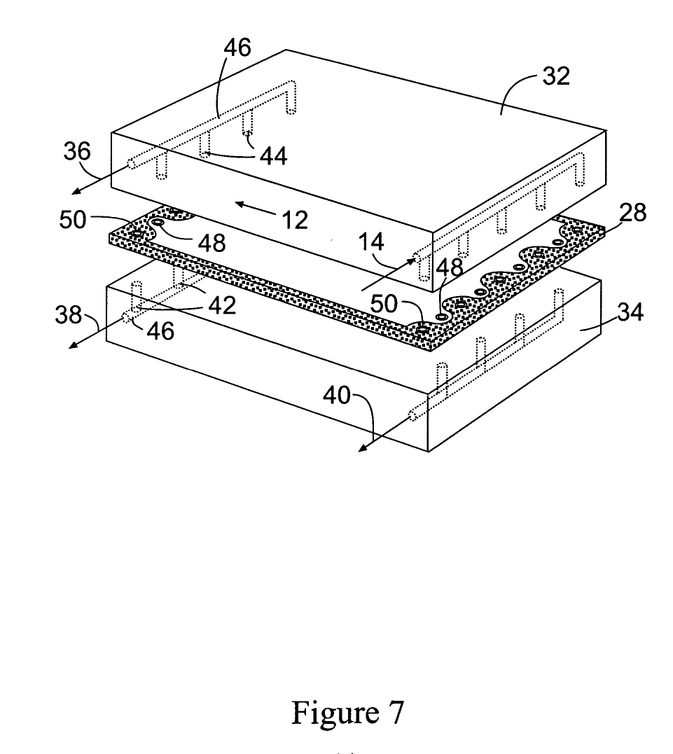

Referring to FIG. 7, a filtration module is shown. A filtration element 28 is positioned between manifold 32 and manifold 34. Manifold 32 is provided with feed inlet 12 and filtrate outlet 36. Manifold 34 is provided with filtrate outlet 38 and retentate outlet 40. One set of filtrate outlet means 42 is provided on the manifold 34 while a second set of filtrate outlet means 44 is provided on the manifold 32. The filtrate outlet means 42 and 44 are connected to filtrate outlets 36 and 38 by filtrate conduit paths 46. The filtration element 28 includes holes 48 which communicate with liquid inlet means 12 and holes 50 which communicate with filtrate outlet means 42 and 44.

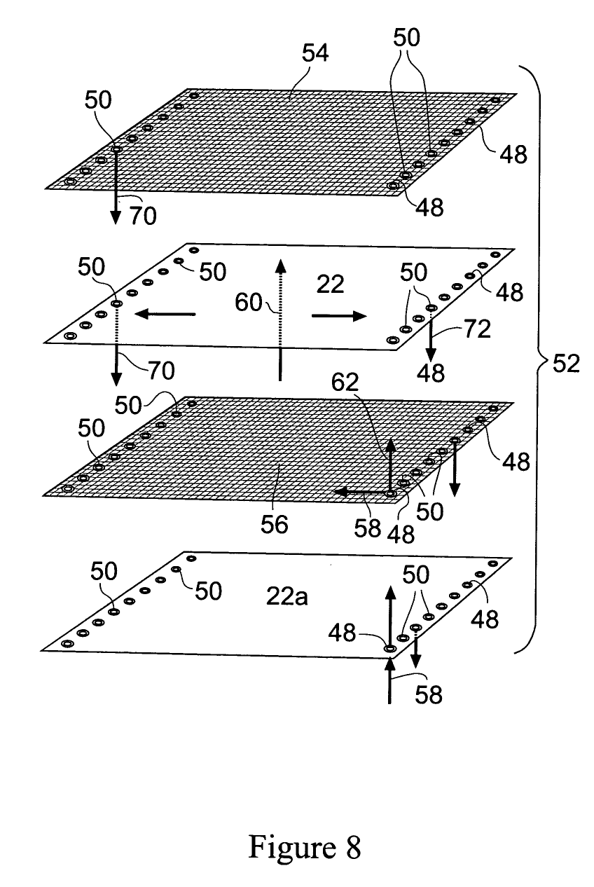

Referring to FIG. 8, the filtration element 52 includes a filtrate spacer 54, a membrane layer 22, a feed spacer 56 and a membrane layer 22 with a second filtrate spacer (not shown) and which can contact conduit paths 46 (FIG. 7). The liquid feed represented by arrow 58 passes through holes 48 in layer 22a into spacer 56. A portion of the liquid passes horizontally through spacer 60 as represented by arrow 58 and vertically through membrane layer 22 as represented by arrow 60. The remaining portion of the incoming liquid passes upwardly as represented by arrow 62, through holes 48 in filter layer 22, holes 48 in filtrate spacer 54 and into the next adjacent filtration member (not shown) wherein it proceeds as described above with reference to filtration element 52. The filtrate passes into holes 50 and passes in a direction as shown by arrows 70 and 72 toward filtrate outlet means 38 (FIG. 4). Holes 48 alternate with holes 50. The retentate passes across filtrate spacer 56 as represented by arrow 64, through holes 50 and to retentate outlet means 40 (FIG. 4).

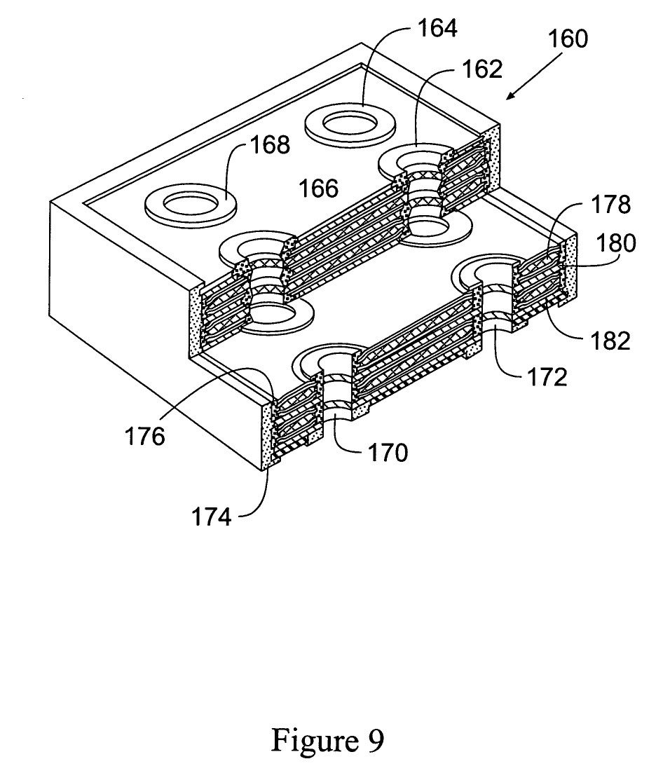

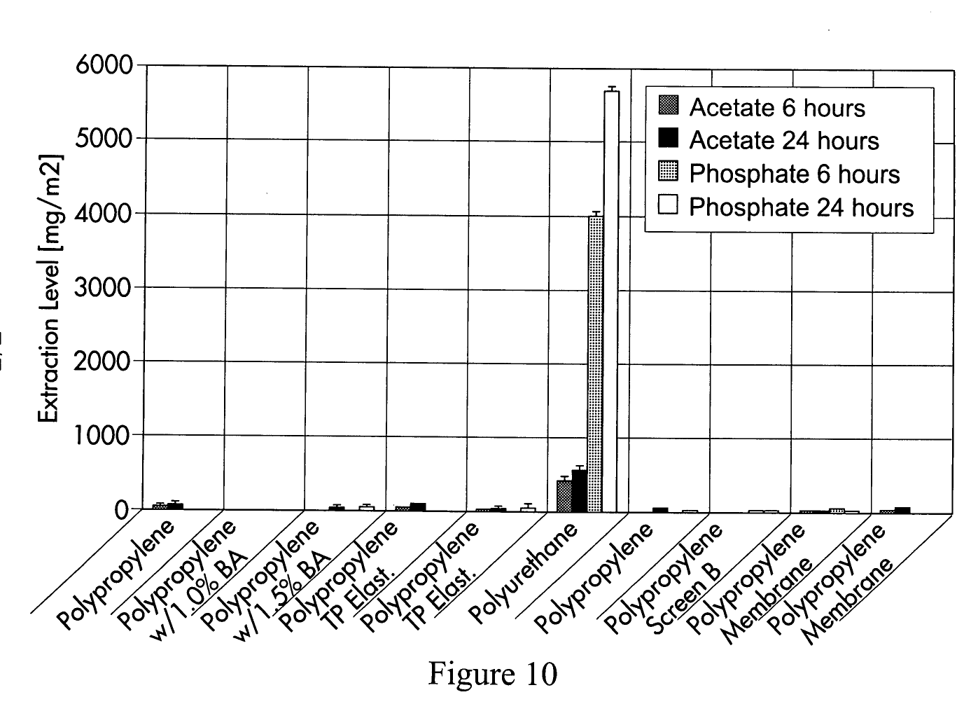

Referring to FIG. 9, the filtration apparatus 80 having inlets 82 and 84 for fluid feed, outlets 86 and 88 for retentate and outlets 90 and 92 for permeate. The filtration apparatus 80 includes an outer shell 94 such as is formed by injection molding, a feed screen 96, a filtrate screen 98 and a membrane layer 100.

As can be appreciated, the design of the components of the present invention and the method of sealing them together allows one to use thinner materials for the components than presently is possible. It also eliminates the need for molded separator plates that also impose a minimum thickness between the components. This results in an increase in the number of layers than can be present in a given volume of the filtration module, thereby desirably increasing the filtration capacity of the module. The present invention is capable of providing a packing density of at least 300 square meters (m²) of active membrane filter area per cubic meter (m³) of external volume of said filter construction, something that has not been available with the prior art devices. The present invention also eliminates the use of two component adhesives that may present questions of cleanliness regarding the presence of unreacted components

In addition, the components and the process for forming them together are desirable as it can eliminate the need for multiple assembly steps to form the membrane-to-screen assembly. Alternatively, it allows one to reduce the number of subassemblies and the steps needed to make them as compared to the other known processes reducing the potential for membrane damage caused by increased handling/processing.

Further, the product of the present invention can have a significantly reduced level of extractables as compared to devices of the prior art. The materials used in the construction of the modules of the present invention as well as those used in the construction of prior art modules were tested to evaluate their level of extractables with typical cleaning solutions for such devices. The test was conducted to determine the ability of a material to take or absorb materials and to subsequently release them. In use, this may result in carry over contamination from one batch of product to the next. This phenomenon is commonly referred to in the industry as extractables.

Samples of identical surface area were made from each individual material to be tested were made to produce samples with uniform surface area. For the thermoplastic and thermoset materials, disks of dimensions of 1.125 inch (28575 cm) diameter by 0.25 inch (1.27 cm) thickness were molded to produce 0.00185 square meters of surface area. For materials of less than 0.025 inch (1.27 cm) thickness such as the membranes, non-woven supports and screens, the samples were cut into circular disks of 47 nm to produce 0l0035 square meter of surface area.

Each sample was soaked individually in 75 ml of the acetic/phosphorous acid test solution for 24 hours. The acid solution used in this study was 1.8% acetic acid and 1.1% phosphoric acid. After soaking, the samples were briefly rinsed with filtered deionized water to remove any residual solution from the surface of the samples. Each sample was then individually soaked in 50 ml of filtered deionized water for extraction. Samples of the water were taken after 6 and 24 hours and analyzed via ion chromatography for the level of acetate and phosphorous ions. The levels of ions were normalized to mg/m². The level of acetate and phosphorous ions present after the described periods of soaking demonstrates the release of residual acid from the material of construction to the water. This corresponds to the level of contamination that the material is capable of releasing in use. Suitable materials are those that have less than 250 mg of extracted contamination per m^{2 of} material when tested by the above described test method. More preferred materials and devices made from them had less than 200 mg of extracted contamination per m² of material when tested by the above described test method.

The use of polypropylene with or without a blowing agent and polypropylene thermoplastic elastomers provided acceptably low extraction levels.

Suitable resilient materials that can be compressed to form a seal and which do not contain extractables include SANTOPRENE® polymers, preferably the 8000 series, available from Advanced Elastomer Systems, L.P. of Akron, Ohio and SARLINK® polymers, preferably the 4155 version, a polypropylene thermoplastic elastomer available from DSM Thermoplastic Elastomers, Inc. of Leominster, Mass. and polypropylene, (typically from 0.5 to about 2.0%).

Suitable thermoplastic polymeric compositions suitable for heat sealing include but not limited to olefins, polypropylenes, polyethylenes, polysulfone, PVDF, PFA, or thermoplastic elastomers.

1. The process for forming a filtration module having a feed inlet port, at least one permeate port and a retentate port which comprises:
forming a stack of a plurality of fluid permeable spacer layers and a plurality of membrane filter layers wherein said spacer layers are positioned alternately with said filter layers in a vertical direction,
providing thermoplastic sections secured to said spacer layers in a configuration such that when said sections are melted, sealing of alternately positioned spacer layers in said feed inlet port, said at least one permeate port and said retentate port are effected such that liquid in said at least one permeate port is not admixed with liquid in said feed port and in said retentate port, the thickness of said thermoplastic sections being between about 100% and about 125% of the thickness of one of said spacer layers.

2. The process of claim 1 wherein said thickness of said thermoplastic sections is between about 110% and about 120% of the thickness of one of said spacer layers.

3. In a filtration module including a multiple of filtration components comprising a filtrate screen, a feed screen and two membrane layers, each having a feed inlet, a filtrate outlet and, optionally a retentate outlet which is sealed to prevent admixture of filtrate with either feed or retentate and wherein feed must pass through a membrane layer prior to entering a filtrate screen, the improvement which comprises providing a thermoplastic polymeric sealing composition about the periphery of each filtrate screen and optionally about the periphery of each feed server wherein the thickness of said thermoplastic polymers sealing composition is between about 100% and about 125% of a filtrate screen or a feed screen.

4. The module of claim 3 wherein each of said feed screens include a compressible polymeric composition about the periphery of said feed screen and wherein said compressible polymeric composition is between about 100% and about 125% the thickness of said feed screen.
